(19) United States
(12) Patent Application Publication
(10) Pub. No.: US 2023/0177936 A1
(43) Pub. Date: Jun. 8, 2023

(54) HOME SECURITY GATEWAY DEVICE WITH INTEGRATED ANTENNAS AND AUDIO ASSEMBLY

(71) Applicant: Syber Sense IP Holdings, LLC, Millcreek, UT (US)

(72) Inventors: Lap Tak Tang, Hong Kong (CN); Barrett Morgan, Millcreek, UT (US)

(21) Appl. No.: 18/078,004

(22) Filed: Dec. 8, 2022

Related U.S. Application Data
(60) Provisional application No. 63/287,432, filed on Dec. 8, 2021.

(51) Int. Cl. G08B 13/22; H01Q 21/30; H04W 76/10; G08B 3/10

(52) U.S. Cl. CPC G08B 13/22; H01Q 21/30; H04W 76/10; G08B 3/10; H04W 88/16

(57) ABSTRACT

A home security gateway device may include a housing body characterized by a perimeter extending about the housing body. The home security gateway device may include a plurality of carrier bodies distributed about and connected proximate the perimeter of the housing body at several mounting locations. Each carrier body may be configured to support a three-dimensional antenna. The home security gateway device may include a plurality of three-dimensional antennas, each received by and connected to a respective carrier body. A first three-dimensional antenna may be configured to send and receive radio frequency signals on one or more first channels, and a second three-dimensional antenna may be configured to send and receive second radio frequency signals on two or more second channels. The first channels may be distinct from the second channels.

### CROSS-REFERENCES TO RELATED APPLICATION(S)

This application is related to and claims the benefit of priority to U.S. Provisional Patent No. 63/287,432, filed Dec. 8, 2021 entitled “Home Gateway with Integrated Antenna and Audio Assembly,” the contents of which is herein incorporated by reference.

### BACKGROUND

Home security systems include a variety of different devices requiring a similar variety of communication protocols. A central control panel must therefore include capabilities to communicate with the variety of devices. The central control panel must be able to communicate with the devices no matter where the devices are places while minimizing both internal and external interference.

### BRIEF SUMMARY

A first example is directed to a home security gateway device that may include a housing body characterized by a perimeter extending about the housing body. The device may also include a plurality of carrier bodies distributed about and connected proximate the perimeter of the housing body at a plurality of mounting locations. The device may also include a plurality of three-dimensional antennas, where a first three-dimensional antenna of the connected to a first carrier body. The first three-dimensional antenna may send and receive radio frequency signals on one or more channels. A second three-dimensional antenna may be connected to another carrier body. The second three-dimensional antenna may be configured to send and receive second frequency signals on two channels. The device may also include one or more processors. The home security gateway device may also include non-transitory computer readable media contained computer-readable instructions. According to the instructions, the home security gateway device may receive a signal on a first channel characterized by a first frequency. The home security gateway device may also determine that the signal includes information associated with a peripheral security device. home security gateway device may access a list that includes the one or more peripheral security devices and two or more channels. Based on the list, the home security gateway device may then determine that the peripheral security device is configured to send and receive signals on a second channel characterized by a second frequency. The home security gateway device may then cause the second three-dimensional antenna to transmit the signal to the peripheral security device on the second channel.

In some embodiments, the first three-dimensional antenna may be configured to send and receive radio frequency signals via Wi-Fi, Bluetooth, 4G, or 5G, and the second three-dimensional antenna is configured to send and receive radio frequency signals using 433 MHz, 345 MHz, 868 MHz, or z-wave 908 mhz. In some embodiments, the second three-dimensional antenna may be a combo antenna, configured to send and receive radio frequency signals on the two or more channels simultaneously. In some embodiments, the home security gateway device may communicate with one or more peripheral security devices and one or more user devices simultaneously.

In some embodiments, the first carrier body is connected to the housing body at a first mounting location, and the second carrier body is connected to the housing body at a second mounting location. The first and second mounting locations may be orthogonally offset from each other. The first and second three-dimensional antennas being configured to send and receive radio frequency signals on a common channel.

In some embodiments, the first carrier body may support the first three-dimensional antenna and a third three-dimensional antenna. The first and third three-dimensional antennas being configured to send and receive radio frequency signals on a common channel. In some embodiments, each three-dimensional antenna is formed in a flat substrate that is flexible to contour around a surface of a respective carrier body of the plurality of carrier bodies.

A second example is directed to a home security gateway device that may include a printed circuit board. The home security gateway device may include three-dimensional antennas electrically connected to the printed circuit board. The home security gateway device may include one or more processors and non-transitory computer readable media connected to the printed circuit board. The non-transitory computer readable media may include computer-readable instructions that cause the home security gateway device to receive, via a three-dimensional antenna, a first signal on a first channel characterized by a first frequency. The home security gateway device may then determine that the first signal includes information associated with a peripheral security device. The home security gateway device may access a list including the peripheral security device and an associated channel characterized by a second frequency. The home security gateway device may then determine that the peripheral security device can send and receive signals on the associated channel. The home security gateway device may cause a second three-dimensional antenna to transmit the signal to the peripheral security device on the second channel.

In some embodiments, the home security gateway device may receive a second signal on the second channel via the second three-dimensional antenna. The second signal may include alert data. The home security gateway device may then determine that the second signal was transmitted by the peripheral security device based at least in part on the alert data. The home security gateway device may access a recipient list including one or more user devices and one or more associated channels. The home security gateway device may generate an alert message based on the alert data. The home security gateway device may transmit the second signal via one or more three-dimensional antennas using the one or more associated channels associated with each of the one or more user devices.

In some embodiments, the plurality of mounting locations are located about the housing body such that a first three-dimensional antenna is connected to a first side of the housing body, a second three-dimensional antenna, is connected to a second side of the housing body, and a third three-dimensional antenna is connected to a third side of the housing body.

In some embodiments, the home security gateway device each three-dimensional antenna is connected to and supported by a carrier body, connected to the housing body via a fastener tab or a screw.

In some embodiments, the signal causes the home security gateway device to pair with the peripheral security device.

A third example is directed to a home security gateway device that may include a housing body characterized by a perimeter extending about the housing body. The home security gateway device may include a plurality of carrier bodies distributed about and connected proximate the perimeter of the housing body at several mounting locations. Each carrier body may be configured to support a three-dimensional antenna. The home security gateway device may include a plurality of three-dimensional antennas, each received by and connected to a respective carrier body. A first three-dimensional antenna may be configured to send and receive radio frequency signals on one or more first channels, and a second three-dimensional antenna may be configured to send and receive second radio frequency signals on two or more second channels. The first channels may be distinct from the second channels.

In some embodiments, at least two mounting locations of the plurality of mounting locations may be disposed on opposite sides of the housing body. In some embodiments, at least three mounting locations may be disposed among three distinct sides of the housing body. In some embodiments, a first carrier body may receive at least one three-dimensional antenna. The carrier body may include by a first arm extending in a first direction and a second arm extending in a second direction. The second direction may be substantially orthogonal to the first direction.

In some embodiments, a first three-dimensional antenna may be configured to send and receive radio frequency signals via Wi-Fi, Bluetooth, 4G, or 5G. A second three-dimensional antenna may be configured to send and receive radio frequency signals via two or more channels. In some embodiments, a carrier body may include a single arm and defines a substantially hollow volume configured to support a three-dimensional antenna. In some embodiments, the home security gateway device includes an audio device to transmit auditory signals.

In some embodiments, the mounting locations may be defined along the perimeter of the housing body, such that an operational range of each of the plurality of three-dimensional antennas is above a predetermined threshold.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 illustrates a home security gateway device, according to certain embodiments.

FIG. 2 illustrates a carrier body with two extending arms, according to certain embodiments.

FIG. 3 illustrates a cross section of a carrier body according to certain embodiments.

FIG. 4 illustrates a home security system configured to transmit signals to one or more peripheral security devices, according to certain embodiments.

FIG. 5 illustrates a method of communicating a signal to one or more peripheral security devices according to certain embodiments.

FIG. 6 illustrates a home security system, configured to transmit signals from one or more peripheral security devices to one or more user devices, according to certain embodiments.

FIG. 7 illustrates a method of communicating a signal to one or user devices, according to certain embodiments.

FIG. 8 illustrates a home security system, according to certain embodiments.

### DETAILED DESCRIPTION

Examples are described herein in the context of home security gateway devices. Those of ordinary skill in the art will realize that the following description is illustrative only and is not intended to be in any way limiting. For example, the features described with respect to the home security gateway devices are applicable to any other home security devices. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

As networking technology and internet of things (IoT) devices has grown and become more prevalent, so have the number of channels and frequencies used for connecting these devices. In an illustrative example a home security system may include one or more peripheral security devices in communication with a central security panel. Some peripheral security devices may operate on different channels than others. For example, in some regions, peripheral security devices may operate on lower frequencies in order to be effective. Lower frequencies may allow for the better transmission of RF signals through materials such as reinforced concrete, as well as increasing the effective range of the RF signal. By contrast, higher frequencies may allow for the faster of transmission of data. Thus, a home security system may have the need for multiple peripheral security devices that operate on different channels.

Older peripheral security devices may also operate on different channels than newer peripheral security devices. This may be due to power constraints, the range needed by the peripheral security device to communicate with another device, or regulatory concerns. Replacing all peripheral security devices may be undesirable or impractical, meaning that any home security system must be able to communicate with both older and newer peripheral security devices. In other words, home security systems must have backwards and forwards compatibility in order to avoid undue costs and inefficiencies.

One solution may be to simply add more antennas into a central security panel in order to communicate with more peripheral devices across various channels. However, this may increase the amount of radio frequency (RF) interference by one or more of the antennas. The RF interference may come from one of the antennas in the central panel or from an external source. Thus, a solution is needed that addresses both the need for forwards and backwards compatibility in home security systems, and for a reduction in RF interference.

To address these and other concerns, described herein is a home security gateway device that includes multiple antennas arranged in specific configurations and configured to minimize RF interference. The specific configurations may be selected to minimize RF interference experienced by any of the antennas, and the multiple antennas may be configured to transmit and receive RF signals on various channels. Furthermore, one or more combo antennas may be used. A combo antenna may be a three-dimensional antenna configured to send and receive RF signals on multiple frequencies, either by selecting a frequency or simultaneously transmitting on multiple frequencies. A frequency switching chip may be used to control the one or more combo antennas that. The combo antennas allow more frequencies to be utilized with less hardware than conventional antennas. Internal shielding may also be used in order to further reduce RF interference, especially interference created by internal components. As described in more detail herein, the home security gateway device configured as described (e.g., including multiple antennas, configured to operate on more than one channel, and being arranged in specific configurations) may address these concerns identified herein. Additionally, such an arrangement may increase an operational range of the home security system, allowing for a single home security gateway device to be deployed even in larger systems.

Turning now to a particular example, in this example is provided a home security gateway device that includes multiple three-dimensional antennas integrated into carrier bodies. The multiple three-dimensional antennas may provide communication across a wide band of frequencies, allowing the home security gateway device to send and receive RF signals to many different peripheral security devices at once. One or more of the three-dimensional antennas may be combo antennas, configured to operate on multiple channels at once and/or configured to operate on different channels at different times. The home security gateway device may also include other three dimensional antennas that operate on just one channel.

The carrier bodies may be arranged around the home security gateway device such that the multiple three-dimensional antennas meet or exceed a required range. To achieve this, some of the three-dimensional antennas may be arranged as a diversity antenna, where the three-dimensional antennas work in conjunction to increase the effective range on a certain frequency. For example, one or more of the combo antennas may be arranged to form a diversity antenna, thereby creating a diversity antenna that operates on several frequencies.

This illustrative example is given to introduce the reader to the general subject matter discussed herein and the disclosure is not limited to this example. The following sections describe various additional non-limiting examples of home security gateway devices.

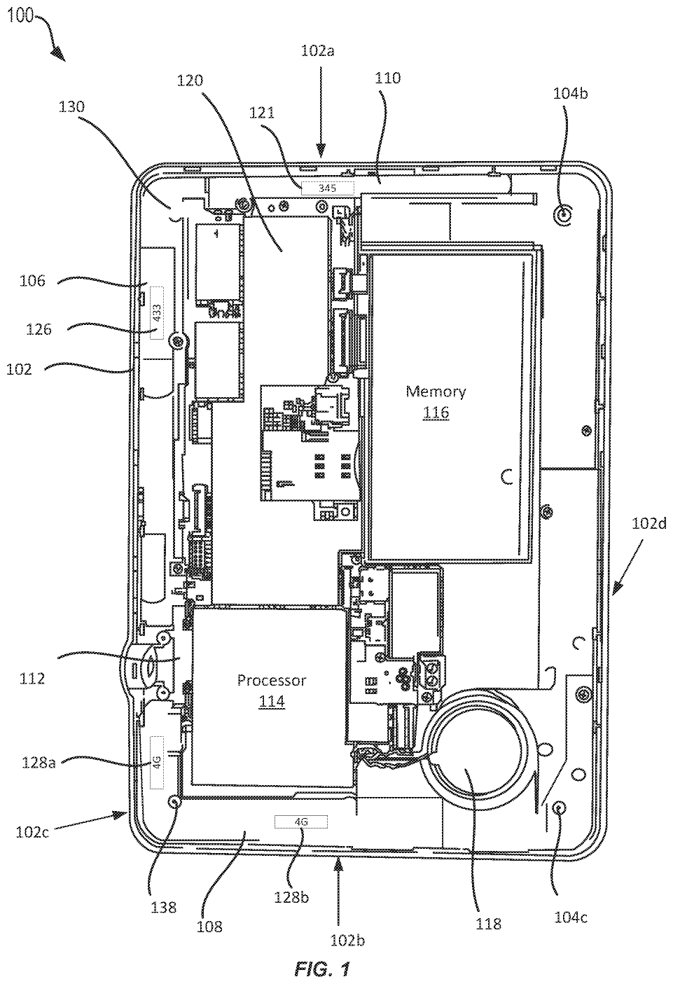

FIG. 1 illustrates a home security gateway device 100, according to certain embodiments. The home security gateway device 100 may include a housing body 102 that defines a perimeter extending about the home security gateway device 100. The housing body 102 may include a first side 102a, a second side 102b, a third side 102c, and a fourth side 102d. The housing body 102 may also include one or more mounting points 104a-d, a few of which are labeled. The home security gateway device 100 may also include a printed circuit board (PCB) 112, a processor 114, a memory 116, an audio source 118, and a frequency switching chip 120.

As described and shown in more detail in subsequent figures, the home security gateway device 100 includes a plurality of carrier bodies 106, 108 and 110. The carrier bodies 106, 108 and 110 are configured to house one or more three-dimensional antennas 121, 126, 128. The carrier bodies 106, 108 and 110 may be connected to the housing body 102 at the mounting points 104a-d by a screw, press tab, or other suitable mechanical connection. Although only four mounting points are shown, in FIG. 1, there may be any number of mounting points disposed anywhere about the perimeter of the housing body 102. Additionally or alternatively, the plurality of carrier bodies may be connected to the housing body 102 via tape, glue or other suitable adhesive. A first single-arm carrier body 106 may be attached to the housing body 102 at least at mounting point 104a, disposed on third side 102c. A second single-arm carrier body 110 may be connected to the housing body 102 at least at mounting point 104b, disposed on first side 102a. Similarly, a double-arm carrier body 108 may be connected to the housing body 102 at mounting point 104d, disposed on second side 102b. In some embodiments, a carrier body may have three arms. The positioning of the carrier bodies 106, 108 and 110 in FIG. 1 is merely presented as an example. In some embodiments, any of the carrier bodies 106, 108 and 110 may be connected to any of the mounting points 104a-d.

Although only three carrier bodies 106, 108 and 110 are shown, any number of carrier bodies may be included in the home security gateway device 100. Furthermore, the carrier bodies 106, 108 and 110 may be disposed on any point of the home security gateway device 100. For example, in some embodiments, the first single-arm carrier body 106 and the second single-arm carrier body 106 may be connected to the housing body 102 on the fourth side 102d, using unshown mounting points. Other configurations are possible, as would be obvious to someone of ordinary skill in the art.

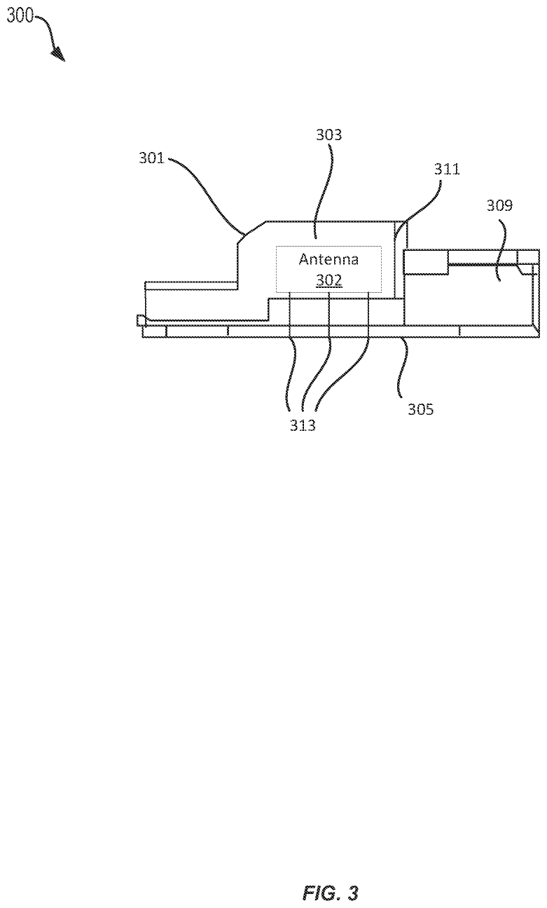

The carrier bodies 106, 108 and 110 may be configured to support a plurality of three-dimensional antennas such as three-dimensional antennas 121, 126, and 128a-b. Each of the one or more three-dimensional antennas may be on a side of one of the plurality of carrier bodies or supported within a volume defined by the carrier body, as is shown in FIG. 3. The plurality of three-dimensional antennas 121, 126, and 128a-b may be configured to send and receive radio frequency (RF) signals on one or more channels, each of the channels being characterized by a radio frequency. The one or more channels may include WiFi, Bluetooth, 4G cellular, 5G cellular, 433 MHz, 345 MHz, 868 MHz, Z-WAVE 908 MHZ, or other suitable frequencies. The plurality of three-dimensional antennas 121, 126, and 128a-b may include integrated circuits on a printed circuit board and/or may be formed on a flat, flexible substrate. The flat substrate may contour around a surface of a carrier body supporting the three-dimensional antenna.

The plurality of carrier bodies may be disposed about the housing body 102 such that an effective range of each of the three-dimensional antennas is above a predetermined threshold (e.g., 20 m through one or more interior walls). For example, the first single-arm carrier body 106 may be connected to a first-three-dimensional antenna 126. Likewise, the second single-arm carrier body 110 may be connected to a second three-dimensional antenna 121. The first three-dimensional antenna 126 may include a combo antenna design configured to send and receive radio frequency signals via channels including 433 MHz, 345 MHz, 868 MHz, and Z-WAVE 908 MHZ. The first three-dimensional antenna 126 may therefore transmit and receive RF signals simultaneously and/or at one at a time by changing modes. The second three-dimensional antenna 110 may also include a combo antenna design and be configured to send and receive radio frequency signals via channels including 433 MHz, 345 MHz, and 868 MHz. In this example, the first single-arm carrier body 106 may be orthogonally offset from the second single-arm carrier body 110. Because of this orthogonality, the performance of each of the first three-dimensional antenna 126 second three-dimensional antennas 121 may be greater than the predetermined threshold on a common channel (in this case, 433 MHz, 345 MHz, and 868 MHz). In other words, the first and second three-dimensional antennas may act as a diversity antenna, where both first three-dimensional antenna 126 and the second three-dimensional antenna 121 work in conjunction to increase an effective range of the home security gateway device 100. Similarly, a third-three-dimensional antenna 128a and fourth three-dimensional antenna 128b may be connected to the double-arm carrier body 108. The positioning of both the third-three-dimensional antenna 128a and the fourth three-dimensional antenna 128b may be substantially orthogonal in relation to each other, and result in another diversity antenna configuration.

The plurality of carrier bodies 106, 108 and 110 may provide an electrical connection to each of the respective three-dimensional antennas from the PCB 112. The electrical connection may be through printed pathways on the PCB 112 terminating into a suitable connection that allows electrical signals to pass. The processor 114, the memory 116, audio source 118 and the frequency switching chip 120 may also be connected to the PCB 112. The memory 116 may include a list or database containing one or more user devices and one or more peripheral security devices, along with one or more channels associated with each. The list or database may be compiled by a previous pairing operation, in which the one or more user devices and the one or more peripheral security devices are paired to the home security gateway device 100. For example, the list may contain information regarding a user device configured to send and receive RF signals on channels including WiFi, 4G, and 5G, and information regarding a peripheral security device configured to send and receive RF signals on channels including 433 Mhz or other channels described herein.

The frequency switching chip 120 may be connected to one or more combo antennas included in the plurality of the three-dimensional antennas, The frequency switching chip 120 may include a switchable crystal and allow the one or more combo antennas to change frequencies in response to a signal from the processor 114. For example, the processor 114 may cause a first signal to be transmitted to a first peripheral security device at a channel including 433 Mhz. The processor 114 may then cause a second signal to be transmitted to a second peripheral security device at a channel including 868 Mhz. The frequency switching chip 120 may cause the one or more combo antennas to enter an 868 MHz broadcasting mode and allow the one or more combo antennas to transmit the second signal.

In some embodiments, the home security gateway device 100 may be configured to communicate with one or more user devices and/or one or more peripheral security devices simultaneously. For example, the home security gateway device 100 may utilize a first three-dimensional antenna to transmit a signal to a first and second user device via a WiFi channel. At the same time, the home security gateway device 100 may utilize a second three-dimensional antenna to transmit the signal to the one or more peripheral security devices via 433 MHz, 345 MHz, and 868 MHz. The second three-dimensional antenna may be a combo antenna configured to transmit the signal from on two channels at the same time. In other embodiments, a third three-dimensional antenna may be used to transmit the signal on a different channel (e.g., the second three-dimensional antenna transmits on 433 MHz while the third three-dimensional antenna transmits on 868 MHz). Thus, signals may be transmitted to multiple devices on multiple channels simultaneously.

The audio device 118 may be configured to emit one or more sounds in response to a signal from the processor 114. For example, the home security gateway device 100 may receive a signal from a peripheral security device. The processor 114 may generate an alert message in response to the signal. The processor 114 may then cause the audio device 118 to emit the alert message. In some embodiments, the alert message may correspond to a tone or other alarm. In other embodiments, the alert message may include spoken information.

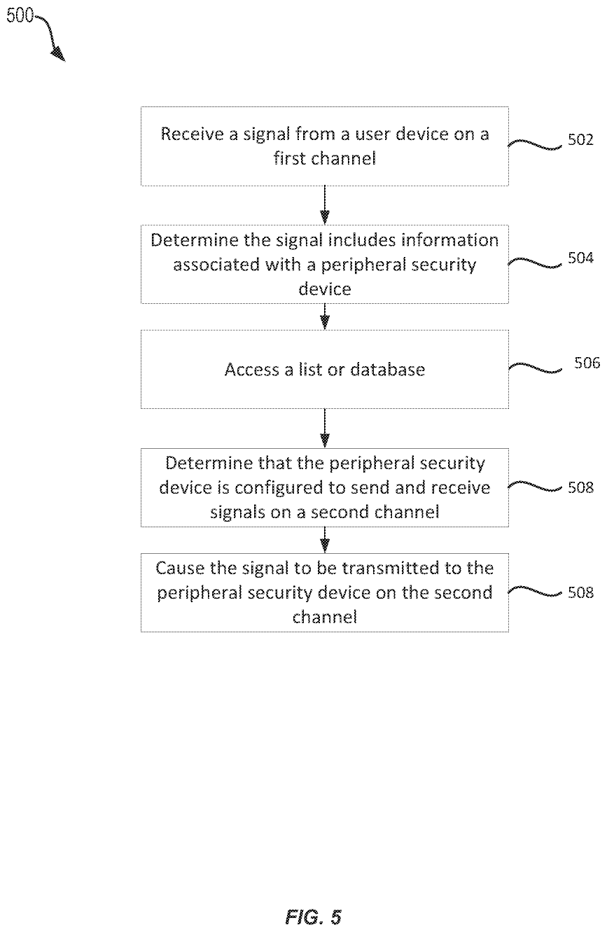

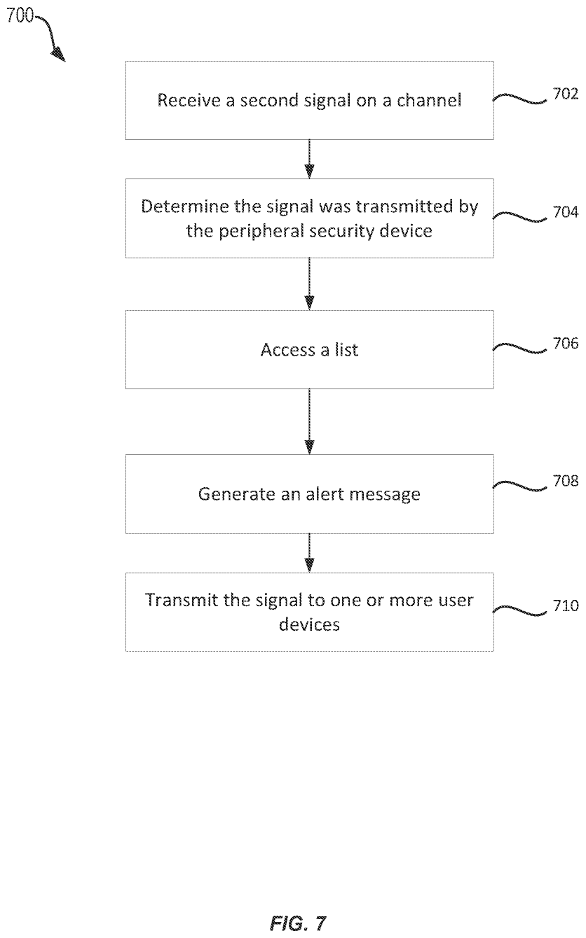

The memory 116 may include a non-transitory device such as a solid-state drive, hard disk drive, random access memory, or other appropriate memory device/format. The memory 116 may include computer readable instructions. The computer-readable instructions, when executed by the processor may cause the home security gateway device 100 to perform certain operations, such as those described in FIGS. 5 and 7.

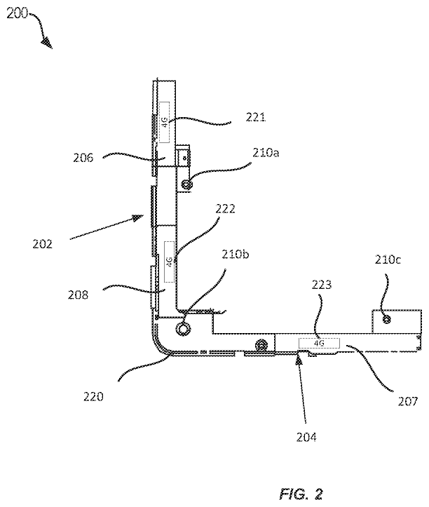

FIG. 2 illustrates a carrier body 200 with two extending arms according to certain embodiments. The carrier body 200 may be similar to the double-arm carrier body 108 in FIG. 1. The carrier body 200 may include a first arm 202 extending in a first direction and a second arm 204 extending in a second direction. The first and second directions may be substantially orthogonal to each other. The carrier body 200 may include antenna housings 206, 207, and 208, where the antenna housing 206-208 are configured to each support a three-dimensional antenna. The carrier body 200 may also include a curved section 220 and one more mounting points 210a-c.

The mounting points 210a-c may be configured to accept screws press tabs, or other suitable mechanical attachments. Additionally or alternatively, the mounting points 210a-c may be configured to utilize tape, glue or other suitable adhesives. Furthermore, the mounting points 210a-c may be located on the carrier body 200 such that each of the mounting points 210a-c mate with a mounting point on a housing body such as the housing body 102 in FIG. 100.

The antenna housings 206-208 may include a substantially hollow space within the first arm 202 and/or second arm 204, respectively. The antenna housings 206-208 may include structures configured to support a three-dimensional antenna. The antenna housings 206-208 may be located on the carrier body 200 such that the spacing between the respective three-dimensional antennas helps an effective range of each of three-dimensional antennas meet or exceed a predetermined threshold (e.g., 20 m through one or more interior walls).

The antenna housing 206-208 may support three-dimensional antennas configured to send and receive RF signals on one or more channels. The one or more channels may include WiFi, Bluetooth, 4G cellular, 5G cellular, 433 MHz, 345 MHz, 868 MHz, Z-WAVE 908 MHZ, or other suitable frequencies. In some embodiments, the antenna housings 206-208 may support three-dimensional antennas configured to operate on the same channel. For example, antenna housings 206-208 may all be configured to send and receive RF signals on a 4G signal. In this example, the antenna housings 206-208 would be configured such that the three-dimensional antennas 221-223 act as a 4G diversity antenna, working in conjunction to increase an effective range of each of the three-dimensional antennas.

In other embodiments, the antenna housings 206-208 may support the three-dimensional antennas 221-223 configured to operate on different channels. For example, the antenna housing 206 may support the three-dimensional antenna 221 that sends and receives RF signals on WiFi. The antenna housing 207 may support the three-dimensional antenna 222 that sends and receives RF signals on 5G. The antenna housing 208 may support the three-dimensional combo antenna 223 that sends and receives RF signals on 433 MHz, 345 MHz, and/or 868 MHz. In yet another embodiment, antenna housing 206 and 207 may support three-dimensional combo antennas 221 and 222 that send and receive RF signals on 433 MHz, 345 MHz, and/or 868 MHz. The antenna housing 208 may support a three-dimensional antenna that sends and receives RF signals on WiFi. Thus, only the three-dimensional combo antennas 221 and 222 in antenna housing 206-207 may act as a diversity antenna, working in conjunction to increase an effective range of the three-dimensional antennas 221 and 223. One of ordinary skill in the art would recognize many different configurations and possibilities.

The curved section 220 may be configured to mate with a curved section of a housing body such as the housing body 100 in FIG. 1. In some embodiments, the curved section 220 may be further configured to support a three-dimensional antenna formed on a flexible substrate. The flexible substrate may contour to fit the curved section 220 of the carrier body 200.

Although FIG. 2 illustrates the carrier body 200 with two arms, a carrier body with one arm is also possible. For example, a carrier body with one arm may be similar to the just the first arm 202. Thus, a carrier body with one arm may include antenna housings similar to antenna housing 206 and 208 and mounting points 210a-b. One of ordinary skill in the art would recognize many different configurations and possibilities.

FIG. 3 illustrates a cross section 300 of a carrier body 301, according to certain embodiments. The carrier body 301 may include a bottom side 305, an antenna housing 303 and an electronics space 309. The carrier body 311 may include shielding 311 between the antenna housing 303 and the electronics space 309. The antenna housing 303 may support a three-dimensional antenna 302.

The carrier body 301 may be constructed out of materials such that RF waves may easily pass through the carrier body 301. The materials may include plastic and other such materials. The antenna housing 303 may be a substantially hollow area within the carrier body 301. The antenna housing 303 may include one or more pathways 313 that allow signals to be transmitted to and from the three-dimensional antenna 302. The pathways 313 may connect the three-dimensional antenna 302 to various components via a PCB, such as the PCB 112, the processor 114, and the frequency switching chip 120 in FIG. 1.

In some embodiments, the antenna housing 303 may support the three-dimensional antenna 302 via a structure formed within the antenna housing 303. In this case, the structure may support the three-dimensional antenna through press fit, screw, press tab, or other mechanical structure. In other embodiments, the antenna housing 303 may simply provide a space for the three-dimensional antenna 302. The three-dimensional antenna 302 may be secured within the antenna housing 303 via screw, press tab, or other mechanical structure. Additionally or alternatively, the three-dimensional antenna 302 may be secured in the antenna housing 303 via tape, glue or other suitable adhesive.

The three-dimensional antenna 302 may include an integrated circuit on a printed circuit board and/or may be formed on a flat, flexible substrate. The three-dimensional antenna 302 may be configured to send and receive radio frequency (RF) signals on one or more channels, each of the channels being characterized by a given radio frequency. The one or more channels may include WiFi, Bluetooth, 4G cellular, 5G cellular, 433 MHz, 345 MHz, 868 MHz, Z-WAVE 908 MHZ, or other suitable frequencies. In some embodiments, the three-dimensional antenna 302 may be a combo antenna, configured to transmit on multiple channels simultaneously. In any event, the three-dimensional antenna 302 may include a high gain antenna.

The electronics space 309 may be configured to allow wires or other electrical pathways to pass through the carrier body 301. In some embodiments, the electronics space 309 may be substantially empty and provide structural support to the carrier body. The electronics space 309 may also be formed to fit the carrier body 301 to a housing body such as the housing body 102 in FIG. 1.

The shielding 311 may reduce RF interference between the three-dimensional antenna 302 housed in the antenna housing 303 and any wires or other electronics disposed in the electronics space 309. The shielding 311 may therefore enable the three-dimensional antenna 302 to include effective range the meets or exceeds a predetermined threshold (e.g., 20 m through one or more interior walls).

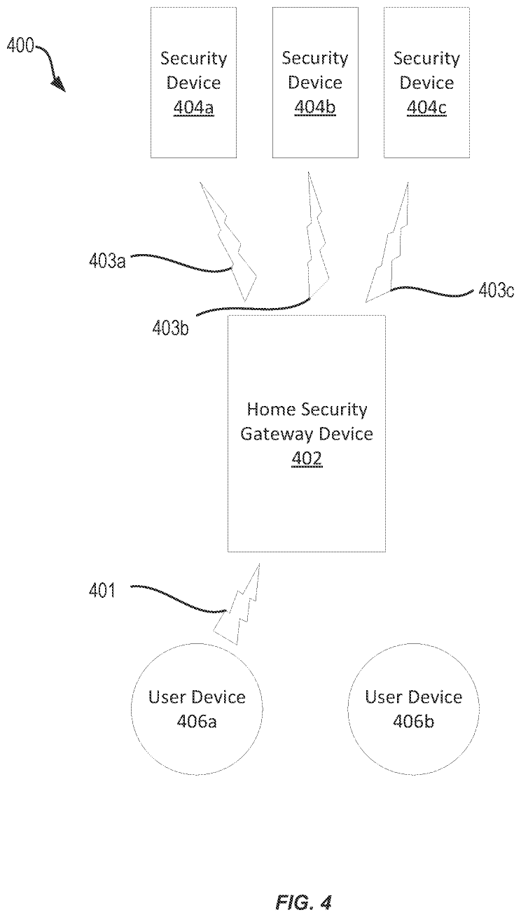

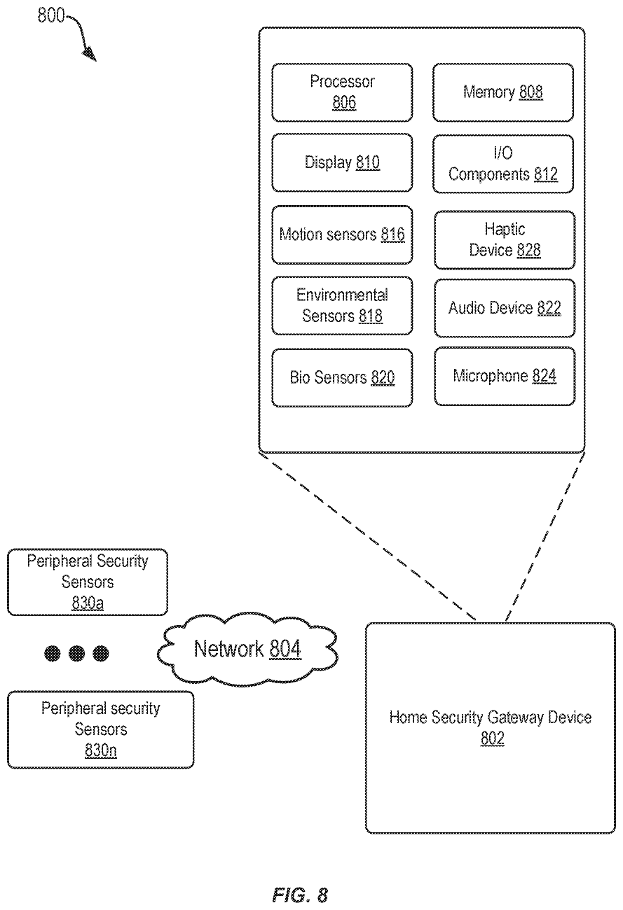

FIG. 4 illustrates a home security system 400 configured to transmit signals to one or more peripheral security devices, according to certain embodiments. The home security system 400 may include a home security gateway device 402, one or more peripheral security devices 404a-c, and one or more user devices 406a-b. The home security gateway device 402 may be similar to the home security gateway device 100 in FIG. 1 and/or home security gateway device 800 in FIG. 8.

The one or more user devices 406a-b may include cellular devices, tablets, personal computers, servers, or other devices capable of communicating via RF signals on one or more channels. The one or more channels may include RF frequencies such as WiFi, Bluetooth, 4G cellular, 5G cellular, 433 MHz, 345 MHz, 868 MHz, Z-WAVE 908 MHZ, and other suitable frequencies.

The one or more peripheral security devices 404a-c may include cameras, motion detectors, optical sensors, or other suitable security devices. The peripheral security devices 404a-c may be configured to send and receive RF signals on one or more channels, including WiFi, Bluetooth, 4G cellular, 5G cellular, 433 MHz, 345 MHz, 868 MHz, Z-WAVE 908 MHZ, and other suitable frequencies. The peripheral security devices 404a-c may operate on 433 MHz and/or lower frequencies due to a reduced power consumption and increased range, especially when transmitting through walls or other structures.

In response to a user input, the user device 406a may transmit a first signal 401 to the home security gateway device 402. The home security gateway device 402 may receive the first signal 401 via a three-dimensional antenna such as the three-dimensional antenna 302 in FIG. 3. The first signal 401 may include identification information associated with the user device 406a.

Upon receiving the first signal 401, the home security gateway device 402 may verify an identity associated with the user device. The home security gateway device 402 may verify the identity of the user device by determining that the user device is included in a list stored in memory such as is described in relation to FIG. 1. The home security gateway device 402 may alternatively or additionally verify the identity via a server or other network resource.

After verifying the identity, the home security gateway device 402 may determine the first signal 401 includes information associated with the one or more peripheral security devices 404a-c. The home security gateway device 402 may access a list or database containing data associated with the one or more peripheral security devices 404a-c, including one or more channels associated with each peripheral security device. The list or database may be stored on a memory device such as the memory device 116 in FIG. 1. Alternatively or in addition, the list or database may be stored on a network resource such as a server.

Using the data in the list or database, the home security gateway device 402 may transmit the information associated with the one or more peripheral security devices 404a-c to the one or more peripheral security devices 404a-c via pushed signals 403a-c. The pushed signals 403a-c may be transmitted via one or more three-dimensional antennas, such as those described in FIGS. 1 and/or FIG. 3. The one or more three-dimensional antennas may transmit the pushed signals using one or more channels including WiFi, Bluetooth, 4G cellular, 5G cellular, 433 MHz, 345 MHz, 868 MHz, and Z-WAVE 908 MHZ. In some embodiments, one or more of the three-dimensional antennas may be combo antennas, able to transmit over one or more channels simultaneously. In another embodiment, a three-dimensional antenna may transmit the pushed signal 403a on a first push channel (e.g., 433 MHz). A frequency switching chip such as the frequency switching chip 120 in FIG. 1 may then cause the three-dimensional antenna to transmit the pushed signal 403b on a second push channel (e.g., 345 MHz). In any case, the home gateway security device 402 may therefore be able to transmit to various peripheral security devices at or near the same time.

In an example, peripheral security device 404a may be a device from a previous security system, configured to send and receive RF signals on a 433 MHz channel. The peripheral security device 404b may be a device added to the security system 400 after the home security gateway device 402 was installed, where the peripheral security device 404b configured to send and receive RF signals on a Z-WAVE 908 MHz channel. Because the home security gateway device 402 may include capabilities to utilize all channels required by the peripheral security devices 404a-b, backwards and forwards compatibility may be provided.

In one example, the first signal 401 may include a signal to arm a home security system. Arming the home security system 400 may include changing the one or more peripheral security devices 404a-c to an on-state. In another embodiment, the first signal 401 may cause one or more of the peripheral security devices 404a-c to pair to the home security gateway device 402. In response to the pairing, the home security gateway device 402 may add data associated with the peripheral security devices 404a-c to the list or database described above.

FIG. 5 illustrates a method 500 of communicating a signal to one or more peripheral security devices, according to certain embodiments. The method 500 may utilize some or all of the systems and devices described in any of the figures above, notably FIG. 1 and FIG. 4. At block 502, a home security gateway device may receive a first signal from a user device on a first channel. The home security gateway device may be the home security gateway device 100 in FIG. 1. The home security gateway device may include plurality of three-dimensional antennas may be configured to send and receive radio frequency (RF) signals on one or more channels, each of the channels being characterized by a given radio frequency. The user device may include cellular devices, tablets, personal computers, servers, or other devices capable of communicating via RF signals on the one or more channels. The one or more channels may include frequencies such as WiFi, Bluetooth, 4G cellular, 5G cellular, 433 MHz, 345 MHz, 868 MHz, Z-WAVE 908 MHZ, or other suitable frequencies. The first signal 401 may include identification information associated with the user device 406a.

At block 504, the home security gateway device may determine that the signal includes information associated with one or more peripheral security devices. The one or more peripheral security devices may be similar to the one or more peripheral security devices 404a-c in FIG. 4.

At block 506, the home security gateway device may access a list or database. The list or database may include data associated with the one or more peripheral security devices including one or more channels associated with each of the one or more peripheral security devices. The list or database may be stored on a memory device such as the memory device 116 in FIG. 1. Alternatively or in addition, the list or database may be stored on a network resource such as a server.

At block 508, the home security gateway device may determine that the one or more peripheral security devices are configured to send and receive RF signals on a second channel. The home security gateway device may access a list or database containing data associated with the one or more peripheral security devices including one or more channels associated with each peripheral security device. The list or database may be stored on a memory device such as the memory device 116 in FIG. 1. Alternatively or in addition, the list or database may be stored on a network resource such as a server.

At block 510, the home security gateway device may cause signal to be transmitted to the one or more peripheral security devices on the second channel. The home security gateway device may transmit the signal via one or more three-dimensional antennas on one or more channels. The signal may be transmitted via one or more three-dimensional antennas, such as those described in FIGS. 1 and/or FIG. 3. The one or more three-dimensional antennas may transmit the pushed signals using one or more channels such as WiFi, Bluetooth, 4G cellular, 5G cellular, 433 MHz, 345 MHz, 868 MHz, and Z-WAVE 908 MHZ. A three-dimensional antenna of the one or more three-dimensional antennas may be a combo antenna, able to transmit over one or more channels simultaneously. In another embodiment, a three-dimensional antenna may transmit the signal on a first push channel (e.g., 433 MHz). A frequency switching chip such as the frequency switching chip 120 in FIG. 1 may then cause the three-dimensional antenna to transmit the signal on a second push channel (e.g., 345 MHz). In any case, the home gateway security device may therefore be able to transmit the signal to various peripheral security devices at or near the same time.

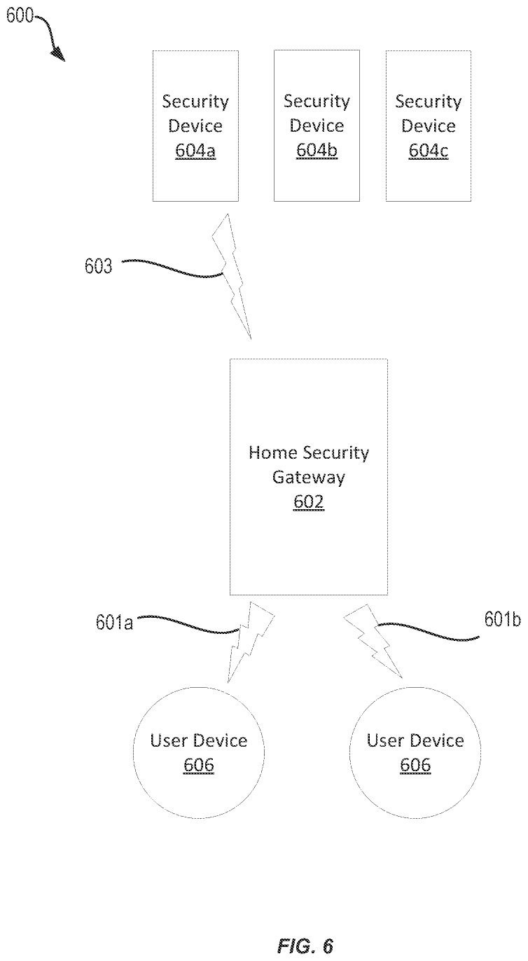

FIG. 6 illustrates a home security system 600, configured to transmit signals from one or more peripheral security devices to one or more user devices, according to certain embodiments. The home security system 600 may include a home security gateway device 602, one or more peripheral security devices 604a-c, and one or more user devices 606a-b. The home security gateway device 602 may be similar to the home security gateway device 100 in FIG. 1. As such, the home security gateway device 602 may include similar components and functionality as the home security gateway device 100.

The one or more user devices 606a-b may include cellular devices, tablets, personal computers, servers, or other devices capable of communicating via RF signals on one or more channels. The one or more channels may include RF frequencies such as WiFi, Bluetooth, 4G cellular, 5G cellular, 433 MHz, 345 MHz, 868 MHz, Z-WAVE 908 MHZ, and other suitable frequencies.

The one or more peripheral security devices 604a-c may include cameras, motion detectors, optical sensors, or other suitable security devices. The peripheral security devices 404a-c may be configured to send and receive RF signals on one or more channels, including WiFi, Bluetooth, 4G cellular, 5G cellular, 433 MHz, 345 MHz, 868 MHz, Z-WAVE 908 MHZ, and other suitable frequencies. The peripheral security devices 604a-c may operate on 433 MHz and/or lower frequencies due to a reduced power consumption and increased range, especially when transmitting through walls or other structures.

The peripheral security device 604a may detect an event such as a moving person, open door, or other action. In response to the detection, the peripheral security device 604a may transmit a signal 603 to the home security gateway device 602 on a first channel. The signal 603 may include alert data based on the event detected by the peripheral security device 604a.

The home security gateway device 602 may receive the signal 603 via a three-dimensional antenna such as the three-dimensional antenna 302 in FIG. 3. Upon receiving the signal 603, the home security gateway device 602 may access a list or database containing data associated with the one or more user devices 606a-b including one or more channels associated with each of the one or more user devices 606a-b. The list or database may be stored on a memory device such as the memory device 116 in FIG. 1. Alternatively or in addition, the list or database may be stored on a network resource such as a server.

The home security gateway device 602 may generate an alert message based on the alert data. The alert message may include an audible alert, text alert, or other suitable notification. Using the data associated with the one or more user devices 606a-b, the home security gateway device 602 may cause the alert signals 601a-b to be transmitted to the one or more user devices 606a-b via one or more three-dimensional antennas. In some embodiments, the alert signals 601a-b may be transmitted using the same channel and frequency (e.g., 5G). In other embodiments, the alert signal 601a may be transmitted using a first channel (e.g., Bluetooth) and the alert signal 601b may be transmitted using a second channel (e.g., WiFi).

In some embodiments, the home security device 602 may include a display. The home security device 602 may cause the display to output a visual alert message for a user. The home security device 602 may also cause the alert message to play via an audio device, such as the audio device 118 in FIG. 1.

FIG. 7 illustrates a method 700 of communicating a signal to one or user devices according to certain embodiments. The method 700 may utilize some or all of the systems and devices described in any of the figures above, notably FIG. 1 and FIG. 6, including the home security gateway device 100 in FIG. 1 and/or the home security gateway device 602 in FIG. 6. At block 702, the home security gateway device may receive a signal on a second channel from one or more peripheral security devices via one or more three-dimensional antennas. The one or more peripheral security devices may include cameras, motion detectors, optical sensors, or other suitable security devices. The peripheral security devices may be configured to send and receive RF signals on one or more channels, including WiFi, Bluetooth, 4G cellular, 5G cellular, 433 MHz, 345 MHz, 868 MHz, Z-WAVE 908 MHZ, and other suitable frequencies. The signal may be similar to the signal 603 in FIG. 6, being generated by at least one peripheral security device in response to a detected event. The signal may include alert data based on the event detected by the peripheral security device.

At block 704, the home security gateway device may determine that the signal was transmitted by the peripheral security device based on the alert data. At block 706, in response to determining the signal was transmitted by the peripheral security device, the home security gateway device may access a list or database containing data associated with the one or more user devices including one or more channels associated with each of the one or more user devices. The list or database may be stored on a memory device such as the memory device 116 in FIG. 1. Alternatively or in addition, the list or database may be stored on a network resource such as a server.

At block 708, the home gateway security device may generate an alert message. The alert message may include an audible alert, text alert, or other suitable notification. At block 710, the home security gateway device may transmit an alert signal including the alert message to the one or more user devices using the associated channels via the one or more three-dimensional antennas. In some embodiments, the alert signal may be transmitted to multiple user devices using the same channel and frequency (e.g., 5G). In other embodiments, the alert signal may be transmitted to a first user device using a first channel (e.g., Bluetooth) and a second user device using a second channel (e.g., WiFi).

In some embodiments, the home security device 602 may include a display. The home security device 602 may cause the display to output a visual alert message for a user. The home security device 602 may also cause the alert message to play via an audio device, such as the audio device 118 in FIG. 1.

FIG. 8 illustrates a home security system 800, according to certain embodiments. The home security system 800 may include a home security gateway device 802 and peripheral security sensors 830a-n. The home security gateway device 802 may communicate with the peripheral security sensors 830a-n over a network 804.

The home security gateway device 802 may include a processing unit 806. The processing unit may include one or more individual processors and communicates with a number of subsystems within the home security gateway device 802. The memory 808 may be similar to the memory 116 in FIG. 1. The memory 808 may include tangible computer-readable storage media such as RAM, ROM, electronically erasable programmable ROM (EEPROM), flash memory or other memory technology, CD-ROM, digital versatile disk (DVD), or other optical storage, solid state drive(s) (SSD) and/or hard disk drives.

The display 810 may include a screen configured to present information to a user. The display 810 may be integrated into the home security gateway device 802 or may be remote, accessed by the network 804 or a separate, wired display device such as a monitor. The I/O components 812 may include user interface input devices and user interface output devices. User interface input devices may include a touchpad or touch screen incorporated into the display 810, a keyboard, pointing devices such as a mouse or trackball, a scroll wheel, a click wheel, a dial, a button, a switch, a keypad, audio input devices with voice command recognition systems, and other types of input devices. The home security gateway device 802 may also include a microphone 824 and an audio device 822. The home security gateway device 802 may include voice recognition sensing devices that enable users to interact with voice recognition systems (e.g., Siri® navigator), through voice commands utilizing the audio device 822 and/or the microphone 824.

The home security gateway device 802 may also include motion sensors 816 that cause the display 810 to enter an on-state in response to detecting motion within a certain proximity. The home security gateway device may also include environmental sensors 818 and bio sensors 820 to detect the presence of a use via thermal detection, retinal data, fingerprint data, etc.

The network 804 may include any network suitable for communication between computing devices, such as a local area network, wide area network, the Internet, or other suitable network types. The network 804 may be accessed using one or more channels, including WiFi, Bluetooth, 4G cellular, 5G cellular, 433 MHz, 345 MHz, 868 MHz, Z-WAVE 908 MHZ, and other suitable frequencies.

The peripheral security sensors 830a-n include cameras, motion detectors, optical sensors, or other suitable security devices. The peripheral security devices 830a-n may be configured to send and receive RF signals on one or more channels, including WiFi, Bluetooth, 4G cellular, 5G cellular, 433 MHz, 345 MHz, 868 MHz, Z-WAVE 908 MHZ, and other suitable frequencies.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A home security gateway device, comprising:
a housing body characterized by a perimeter extending about the housing body;
a plurality of carrier bodies distributed about and connected proximate the perimeter of the housing body at a plurality of mounting locations;
a plurality of three-dimensional antennas, wherein a first three-dimensional antenna of the plurality of three-dimensional antennas is connected to a first carrier body of the plurality of carrier bodies and is configured to send and receive first radio frequency signals on one or more first channels, and wherein a second three-dimensional antenna of the plurality of three-dimensional antennas is connected to a second carrier body of the plurality of carrier bodies and is configured to send and receive second radio frequency signals on two or more second channels;
one or more processors;
one or more non-transitory computer readable media comprising computer-readable instructions that, when executed by the one or more processors, cause the home security gateway device to perform operations comprising:
receiving, via the first three-dimensional antenna, a signal on a first channel of the one or more first channels, wherein the first channel is characterized by a first frequency;
determining that the signal comprises information associated with a peripheral security device;
accessing a list comprising the one or more peripheral security devices and the two or more second channels
determining that the peripheral security device is configured to send and receive signals on a second channel of the two or more second channels, wherein the second channel is characterized by a second frequency based on the list; and
causing the second three-dimensional antenna to transmit the signal to the peripheral security device on the second channel.

2. The home security gateway device of claim 1, wherein the first three-dimensional antenna is configured to send and receive radio frequency signals via WiFi, Bluetooth, 4G, or 5G, and the second three-dimensional antenna is configured to send and receive radio frequency signals via the two or more channels comprising two or more of 433 MHz, 345 MHz, 868 MHz, or Z-WAVE 908 MHZ.

3. The home security gateway device of claim 1, wherein the second three-dimensional antenna is a combo antenna, configured to send and receive radio frequency signals on the two or more channels simultaneously.

4. The home security gateway device of claim 1, wherein the one or more non-transitory computer readable media comprise additional computer-readable instructions that, when executed by the one or more processors, cause the home security gateway device to perform additional operations comprising communicating with one or more peripheral security devices and one or more user devices simultaneously.

5. The home security gateway device of claim 1, wherein the first carrier body is connected to the housing body at a first mounting location of the plurality of mounting locations, wherein second carrier body is connected to the housing body at a second mounting location of the plurality of mounting locations that is orthogonally offset from the first mounting location, the first and second three-dimensional antennas being configured to send and receive radio frequency signals on a common channel.

6. The home security gateway device of claim 1, wherein the first carrier body is configured to support the first three-dimensional antenna and a third three-dimensional antenna, the first and third three-dimensional antennas being configured to send and receive radio frequency signals on a common channel.

7. The home security gateway device of claim 1, wherein each three-dimensional antenna of the plurality of three-dimensional antennas is formed in a flat substrate that is flexible to contour around a surface of a respective carrier body of the plurality of carrier bodies.

8. A home security gateway device, comprising:
a printed circuit board;
a plurality of three-dimensional antennas electrically connected to the printed circuit board;
one or more processors electrically connected to the printed circuit board; and
one or more non-transitory computer readable media electrically connected to the printed circuit board and comprising computer-readable instructions that, when executed by the one or more processors, cause the home security gateway device to perform operations comprising:
receiving, via a first three-dimensional antenna of the plurality of three-dimensional antennas, a first signal on a first channel characterized by a first frequency;
determining that the first signal comprises information associated with a peripheral security device;
accessing a list comprising the peripheral security device and an associated channel characterized by a second frequency;
determining that the peripheral security device is configured to send and receive signals on the associated channel based on the list; and
causing a second three-dimensional antenna of the plurality of three-dimensional antennas to transmit the signal to the peripheral security device on the second channel.

9. The home security gateway device of claim 8, wherein the signal is a first signal, and wherein the computer-readable instructions further cause the processors to perform operations comprising:
receiving a second signal on the second channel via the second three-dimensional antenna, wherein the second signal comprises alert data;
determining that the second signal was transmitted by the peripheral security device based at least in part on the alert data;
accessing, in response to the alert data, a recipient list comprising one or more user devices and one or more associated channels from the one or more non-transitory computer readable media;
generating an alert message based on the alert data; and
transmitting the second signal via one or more three-dimensional antennas of the plurality of three-dimensional antennas using the one or more associated channels associated with each of the one or more user devices.

10. The home security gateway device of claim 8 further comprising a housing body that defines a plurality of mounting locations for the plurality of three-dimensional antennas, wherein the plurality of mounting locations are located about the housing body such that a first three-dimensional antenna of the plurality of three-dimensional antennas is connected to a first side of the housing body, a second three-dimensional antenna of the plurality of three-dimensional antennas is connected to a second side of the housing body, and a third three-dimensional antenna of the plurality of three-dimensional antennas is connected to a third side of the housing body.

11. The home security gateway device of claim 10, each three-dimensional antenna is connected to and supported by a carrier body that is connected to the housing body at one of the plurality of mounting locations via a fastener tab or a screw.

12. The home security gateway device of claim 8, wherein the signal causes the home security gateway device to pair with the peripheral security device.

13. A home security gateway device, comprising:
a housing body characterized by a perimeter extending about the housing body;
a plurality of carrier bodies distributed about and connected proximate the perimeter of the housing body at a plurality of mounting locations, wherein each carrier body of the plurality of carrier bodies is configured to support a three-dimensional antenna; and
a plurality of three-dimensional antennas, each received by and connected to a respective carrier body, wherein a first three-dimensional antenna of the plurality of three-dimensional antennas is configured to send and receive first radio frequency signals on one or more first channels, wherein a second three-dimensional antenna of the plurality of three-dimensional antennas is configured to send and receive second radio frequency signals on two or more second channels, and wherein the one or more first channels are distinct from the two or more second channels.

14. The home security gateway device of claim 13, wherein at least two mounting locations of the plurality of mounting locations are disposed on opposite sides of the housing body.

15. The home security gateway device of claim 14, wherein at least three mounting locations of the plurality of mounting locations are disposed among three distinct sides of the housing body.

16. The home security gateway device of claim 13, wherein a first carrier body is configured to receive at least one three-dimensional antenna, and is characterized by a first arm extending in a first direction and a second arm extending in a second direction, the second direction being substantially orthogonal to the first direction.

17. The home security gateway device of claim 13, wherein a first three-dimensional antenna of the plurality of three-dimensional antennas is configured to send and receive radio frequency signals via WiFi, Bluetooth, 4G, or 5G, and a second three-dimensional antenna of the plurality of three-dimensional antennas is configured to send and receive radio frequency signals via two or more channels.

18. The home security gateway device of claim 13, wherein a second carrier body comprises a single arm and defines a substantially hollow volume configured to support a three-dimensional antenna.

19. The home security gateway device of claim 13, further comprising an audio device configured to transmit auditory signals.

20. The home security gateway device of claim 13, wherein the plurality of mounting locations is defined along the perimeter of the housing body, such that an operational range of each of the plurality of three-dimensional antennas is above a predetermined threshold.
